(19) United States
(12) Patent Application Publication
(10) Pub. No.: US 2007/0089624 A1
(43) Pub. Date: Apr. 26, 2007

(54) Systems and methods for integrated extended process media productions

(75) Inventor: David C. Allen, Denver, CO (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: QUARK, INC., Denver, CO (US)

(21) Appl. No.: 11/095,705

(22) Filed: Mar. 30, 2005

(51) Int. Cl. B41F 33/00

(52) U.S. Cl. 101/483

(57) ABSTRACT

Systems and methods are provided for developing media productions that utilize extended press functionality. According to one embodiment, special plate and standard plate requests are received, and the special and standard plates are incorporated into a media production. The media production may be displayed including both the special plates and the standard plates. In some cases, one or more press identifications are received that identify at least some of the various capabilities of available presses. Based upon the press identifications, one or more portions of the media production that are compatible with the capabilities of each of the available presses may be identified and associated with the appropriate available presses.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2005 Quark, Inc.

### CROSS REFERENCE TO RELATED APPLICATIONS

The present application is related to U.S. patent application Ser. No. ______ (Attorney Docket No. 56578-315714) entitled “Systems And Methods For Importing Color Environment Information”, and filed by Allen on a date even herewith. Further, the present application is related to U.S. patent application Ser. No. ______ (Attorney Docket No. 56578-309581) entitled “Systems And Methods For Media Production Color Management”, and filed by Allen on a date even herewith. The entirety of the aforementioned patent applications is incorporated herein by reference for all purposes.

### BACKGROUND OF THE INVENTION

Various embodiments of the present invention generally relate to systems and methods for the development of media productions. More particularly, embodiments of the present invention relate to systems and methods for preparing media productions that require the use of one or more special attributes, such as special printing effects, foil stamps, embossing, cutouts, and the like.

Historically, the development of media productions that use special printing techniques have required many tedious and time consuming workarounds in order to generate the necessary separation plate layouts. These difficulties have been exacerbated where the media production is a complex document that includes many items layered on top of each other. Also, much of the work used to generate the separation plate layouts would be lost when modifications to the media production occurred.

Hence, there exists a need in the art for systems and methods offering the ability to apply and visually display information regarding special attributes, such as special printing effects, foil stamps, embossing, cutouts, and the like, and the like, in media productions.

### BRIEF SUMMARY OF THE INVENTION

Systems and methods are described for the development of media productions. More particularly, embodiments of the present invention relate to systems and methods for preparing media productions that require the use of one or more special printing techniques.

Various embodiments of the present invention provide systems and methods for integrated extended process media productions. Various of the systems and methods include a computer and a computer readable medium that includes instructions that can be executed by the computer. In some cases, the instructions are executable to output the media production in accordance with an output model. Examples of output models include, but are not limited to, CMYK, DeviceN, and host-based separation. In various cases, the instructions are capable of applying special plates to many objects. Examples of the objects to which special plates may be applied include, but are not limited to, a bezier curve (such as a simple curve, straight line, or a recurve), a closed bezier line, a non-bezier line, a frame, a text character, a graphic, a clipping path in an imported graphic, a working path in an imported graphic, and to spot inks in an imported graphic.

Some embodiments of the present invention provide systems for integrated extended process media productions. Such systems include a computer and a computer readable medium including instructions executable to receive requests for special and standard plates and incorporate the special and standard plates into a media production. In some cases of the embodiments, the special plate includes trapping information that may be, but is not limited to, a varnish class, a special effect ink class, and a die class. In some instances, the varnish class includes, but is not limited to, a dull varnish plate, a glossy varnish plate, and an ultra-violet coating varnish plate. The special effect ink class, in some cases, includes, but is not limited to, a textured ink, a metallic ink, and a spot ink. The die class may include, but is not limited to, a foil stamp, an embossing, and a cutout. In various cases, the standard plate may be, but is not limited to, a four color ink graphic and a four color ink text. The standard plates may also include trapping information in some embodiments of the present inventions.

Yet other embodiments of the present invention provide methods for developing media productions that utilize extended press functionality. In the methods, special plate and standard plate requests are received, and the special and standard plates are incorporated into the media production. Some of the various embodiments have the capability of displaying the media production including both the special plates and the standard plates. In some cases, one or more press identifications are received that identifies at least some of the various capabilities of available presses. In one or more various embodiments of the present invention, the computer may identify and associate a portion of the media production that is compatible with the capabilities of each of the available presses.

In yet other embodiments of the present invention provide systems for integrated extended process media productions that include a computer readable medium executable by the computer to receive a request for a special plate, incorporate the special plate in the media production and display the media production with the special plate displayed in relation to other elements of the media production.

This summary provides only a general outline of some embodiments of the present invention. Many other objects, features, advantages and other embodiments of the present invention will become more fully apparent from the following detailed description, the appended claims and the accompanying drawings.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates a media production system according to one embodiment of the present invention.

FIG. 2 is a simplified flow diagram illustrating integrated extended process media production design flow according to one embodiment of the present invention.

FIG. 3 is a flow diagram illustrating extended media production design flow in accordance with one embodiment of the present invention.

FIG. 4 is a block diagram illustrating a document preparation process according to one embodiment of the present invention.

FIG. 5 is an example of a media production incorporating a variety of special attributes.

### DETAILED DESCRIPTION OF THE INVENTION

The present disclosure describes inventive systems and methods related to producing media productions, and in particular to systems and methods for color management in relation to media productions.

Systems and methods are described for preparing and printing media productions that employ one or more special attributes. There are three common classes of plates: varnish; ink; and die. The varnish class includes, but is not limited to, effects such as UV coatings, tints, glossy coats, and dull coats. This class may not interact with the color or ink of the object to which it is applied but will interact with objects underneath that also have a varnish applied. The ink class includes, but is not limited to, effects such as reapplying a coating of ink and applying ink over a large area. These types of plates specify standard inks used as an affect to enhance objects and graphics or apply two hits of the same ink to improve coverage. Ink classes can also be applied in tints and blends and is subject to color management like any other ink. The die class includes, but is not limited to, effects such as foil stamps, embossing, and die cuts. Die class concepts do not care about other object colors, inks, or their interactions.

Historically, the use of special printing techniques such as varnish, emboss or bump plates have required many tedious and time consuming workarounds in order to generate the necessary separation plates. This was especially true with complex documents that included many items layered one on top of the other or when modifications occurred.

For example, in the case of varnish, some users would duplicate the object, color the object on top with a spot color named varnish and tell the varnish object to overprint. Other users would save the document as something entirely different, delete all of the content to which the special plates did not apply and apply a special spot color called “varnish” to the remaining objects with the appropriate tints. In this case, if an object was subsequently moved or changed size, added or deleted from the original layout, the varnish layout would also have to be updated.

Another prior manual work around method was to print a piece, delete all the content that one didn't want the effect applied to, apply the effect to the remaining objects, and then re-run the print job back through the press so the effect is applied to the appropriate objects.

While each special printing technique, such as varnish, emboss, foil stamp, or bump plates, has different considerations, they all involve a shape that is registered in a specific location on the page. Furthermore, each technique or plate has its own printing tolerances called trappings. One embodiment of the present invention allows for these tolerances to be displayed in one design tool. In addition, embodiments of the present invention eliminate the need for the time consuming workarounds described above by providing a completely integrated, one stop, document preparation system. This system recognizes tolerances of special plates along with tolerances of other design concepts including inks.

According to embodiments of the present invention, a computer and a computer readable medium may be provided that include instructions, which are executable by the computer, to output a media production in accordance with an output model. Other embodiments of the present invention generally relate to systems comprising a computer and a computer readable medium including instructions executable to receive requests for special and standard plates and incorporate the special and standard plates into a media production and display the media production with the special plate displayed in relation to other elements of the media production. In some cases, one or more press identifications are received that identifies at least some of the various capabilities of available presses. In one or more various embodiments of the present invention, the computer may identify and associate a portion of the media production that is compatible with the capabilities of each of the available presses.

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Embodiments of the present invention include various steps, which will be described below. The steps may be embodied in machine-executable instructions. The instructions can be used to cause a general-purpose or special-purpose processor that is programmed with the instructions to perform the steps. Alternatively, the steps may be performed by specific hardware components that contain hardwired logic for performing the steps, or by any combination of programmed computer components and custom hardware components. Embodiments of the present invention may be provided as a computer program product which may include a machine-readable medium having stored thereon instructions which may be used to program a computer (or other electronic devices) to perform a process according to embodiments of the present invention. The machine readable medium may include, but is not limited to, floppy diskettes, optical disks, CD-ROMs, and magneto-optical disks, ROMs, RAMs, EPROMs, EEPROMs, magnet or optical cards, flash memory, or other types of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

While, for convenience, embodiments of the present invention are described in the context of a document preparation system and printing of documents on printing presses, the present invention is equally applicable to various other environments in which various apparatus may apply text and/or designs to other materials. For example, embodiments of the present invention are thought to have application to screen printing of T-shirts, custom embroidery of garments, and the like.

Brief definitions of terms and/or phrases used throughout this application are given below. The terms “connected” or “coupled” and related terms are used in an operational sense and are not necessarily limited to a direct connection or coupling. Thus, for example, two devices may be coupled directly, or via one or more media or devices. As another example, devices may be coupled in such a way that information can be passed therebetween, while not sharing any physical connection one with another. Based on the disclosure provided herein, one of ordinary skill in the art will appreciate a variety of ways in which connection or coupling exists in accordance with the aforementioned definition.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

The phrase “integrated extended process media production” generally refers to a media production in which standard and special plates coexist and need not be manually processed to generate multiple separation plate layouts prior to printing. Typically, the manifestation of an integrated extended process media production in the form of a printed document, for example, includes processing by multiple presses, such as printing presses and/or special plate presses. However, rather than requiring the manual generation of separation plate layouts corresponding to the multiple presses as required by existing extended process printing methodologies, according to one embodiment of the present invention a method is provided within a software application program, design tool, or document preparation system that automates the extraction and delivery of appropriate information from an integrated extended process media production to corresponding presses associated with a particular extended process. In another embodiment, an automated separation method may be operable within presses responsive to receiving a print job to identify and process only those components which the press is capable of processing.

The phrase “printing press” generally refers to a device or system capable of fixing a media production onto a physical media. Thus, for example, a printing press may be a four color CMYK printing press, an ink jet printer, a laser printer, a screen printer, and/or the like. The phrase “media production” generally refers to a design that can be implemented in a particular media. Thus, as just some examples, a media production can be, but is not limited to, a printed document design, a web page design, a clothing design, a video design, combinations thereof, and/or the like. The phrase “special attribute” generally refers a printing process that would generally be considered beyond a standard four color ink process. Thus, for example, a special attribute may indicate a varnish class, a special effect ink class, a die class or other special printing effect or technique. The phrase “special ink effect” generally refers to, but is not limited to, textured ink, metallic ink, spot ink or the like.

The phrase “special plate” is used in different contexts herein. In one context, such as the context of a software application program, design tool, or document preparation system for creating, editing or otherwise manipulating or viewing media productions, the phrase “special plate” generally refers to information about a special attribute associated with a portion of a media production. In one embodiment, a special plate may include information regarding a shape and size of a special printing effect. A special plate may also include information regarding printing tolerances of a special printing effect referred to as “trappings” or “trapping information.” Special plates may be displayed in a media production in relation to other elements of the media production to provide an end user with visual feedback regarding potential interactions and/or effects of special plates with or upon the other elements. In another context, such as the context of a press, the phrase “special plate” generally refers to the actual equipment used to implement a special plate such as, for example, a die cut machine. If the specification states a component or feature “may”, “can”, “could”, or “might” be included or have a characteristic, that particular component or feature is not required to be included or have the characteristic.

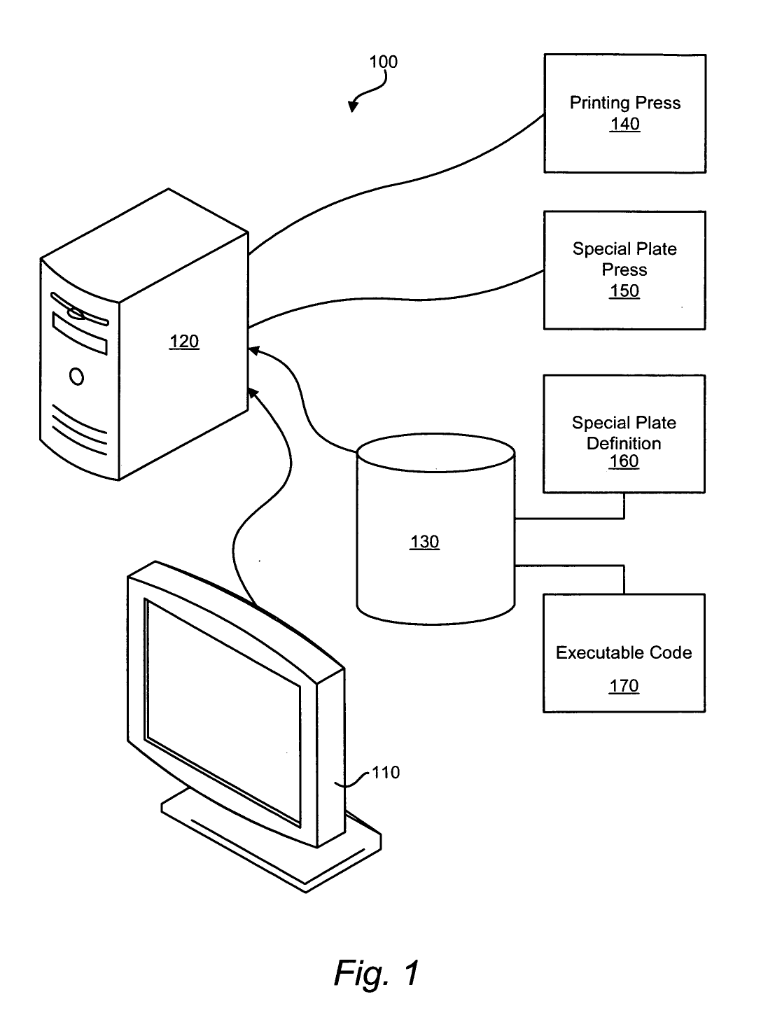

One embodiment of the present invention is illustrated in FIG. 1. According to the embodiment depicted in FIG. 1, media production system 100 includes a monitor 110, a computer 120, a storage device 130, a printing press 140, a special plate press 150, special plate definitions 160, and executable code 170.

The monitor 110 displays the user interface (UI) for the machine executable code 170 which is executed by the computer 120. The user will produce a media production incorporating various standard and special plates into the design using the UI. The machine executable code 170 incorporates the special plate definitions 160 into the design process. Once the user has finished the media production, the media production is separated into various components and printed. The separation of the media production could occur at the computer 120. It is also possible for the entire file to be sent to the printing press 140 and special plate press 150, at which point the printer separates the file into components which can be printed on that press. According to the embodiment depicted, the printing press 140 is separate from and independent of the special plate press 150. In one embodiment, these presses may be integrated within a multiple functionality press. Additionally, particular media production systems may include more than one printing press 140 and/or more than one special plate press 150 to accommodate various extended processing requirements.

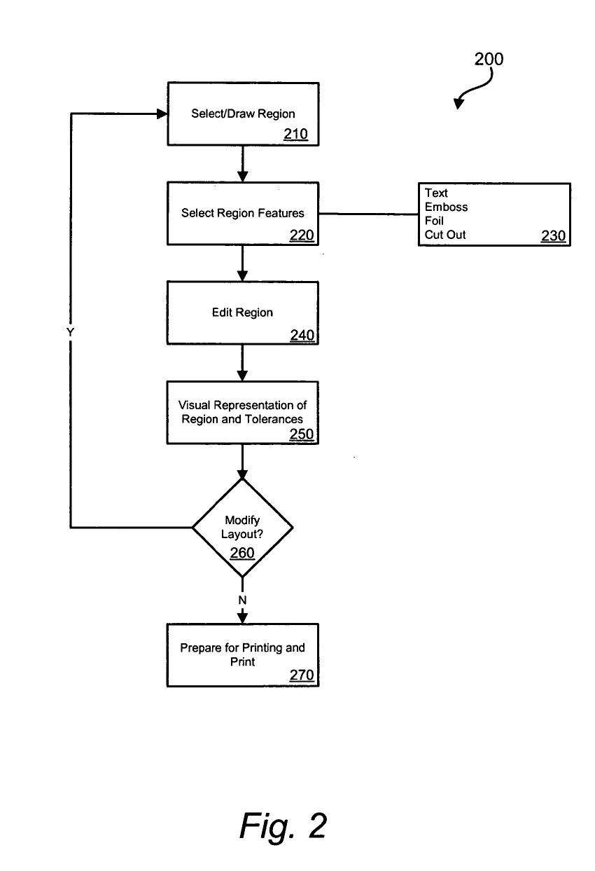

Having briefly described an exemplary media production system 100, a block diagram 200 representing a high level overview of user interactions with a user interface according to one embodiment of the present invention will now be described with reference to FIG. 2. FIG. 2 is a simplified block diagram representing one embodiment of the media production process. The user may start with either a blank layout or an existing media production. In either case, the user then selects or draws a region at block 210. Selection or identification of a particular portion or object within a media production may be performed in accordance with a variety of existing techniques commonly know to those skilled in the art. Examples include, but are not limited to, bounding boxes and the like. Once the region is drawn or selected, the user then selects the desired region features at block 220. These features commonly include, but are not limited to, text, emboss, foil, and/or cut outs 230.

At block 240, the user may then edit the region appropriately with the addition, deletion, or modification of features in the region or by moving or modifying the region itself. These changes are represented visually along with indications of the various regions and their related tolerances at block 250. If the user desires to modify the layout, block 260, then the process may be repeated with the selection or drawing of a region at block 210. If, however, the user has completed desired modifications to the layout, block 260, the document can be prepared and printed at block 270.

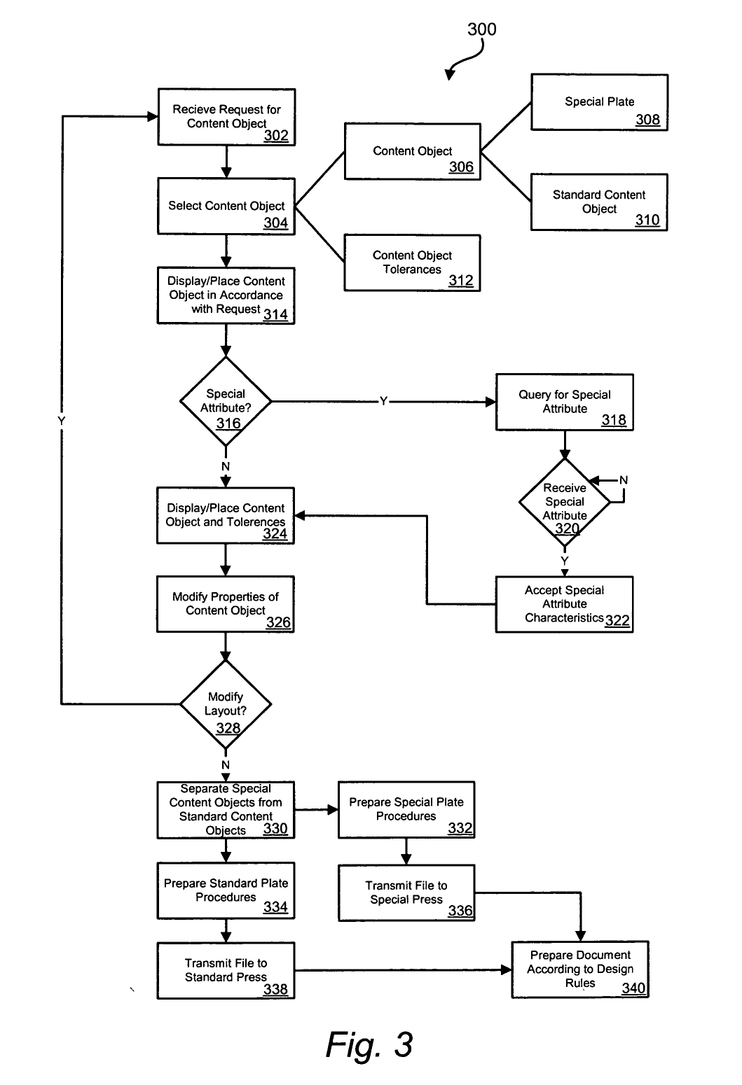

FIG. 3 provides a more detailed flow diagram illustration 300 of a media production process in accordance with one embodiment of the present invention. According to the present example, the machine executable code 170 receives a request for a content object, block 302. Examples of the manner in which the user can place a request for a content object include using the drop down menu in the UI or entering commands at a command prompt. The user then selects the desired content object, block 304. Examples of content objects 306 include, but are not limited to, special plates 308 and other standard content objects 310. Included with the selection of the desired content object in block 304 is an associated content object tolerance 312. According to various embodiments, these tolerances are part of the special plate definition 160. Such tolerances are typically dependent on ink type, paper type and the type of plate used.

At block 314, the content object is placed in the media production layout in accordance with the design request. If the content object requires a special attribute then a prompt or query for a special attribute, block 318, is sent to the user. If no special attribute is received at block 320 then the system continues to wait for the receipt of a special attribute. Once the special attribute is received at block 320, the special attribute characteristics are accepted at block 322. Then, the object and tolerances are displayed on the UI.

If, however, the content object does not require a special attribute, then the content objects and tolerances are displayed at block 324. Once the content object and tolerances are displayed, block 324, the user may then modify the properties of the content object. If the user desires to modify the layout, block 328, then the user can make a new request for a content object and the process will start over at block 302. If the user does not desire to modify the layout at block 328, the document is then prepared and printed. In the embodiment illustrated by flow diagram 300, the first step in the preparation for printing is the separation of special content objects from standard content objects at block 330.

Then, appropriate print jobs or files are prepared according to the special plate procedures, block 332, and also prepared according to the standard plate procedures, block 334. The special plate file is then transmitted to the special press, block 336, and the standard press file is transmitted to the standard press, block 338. As discussed above, presses may have internal functionality to allow them to filter out printing effects contained within print jobs or files that are beyond their capabilities and only perform printing effects within their capabilities, thereby allowing blocks 332 and 334 to essentially be performed within the individual presses associated with manifesting an extended process media production. Finally, the document is prepared according to the design rules at block 340.

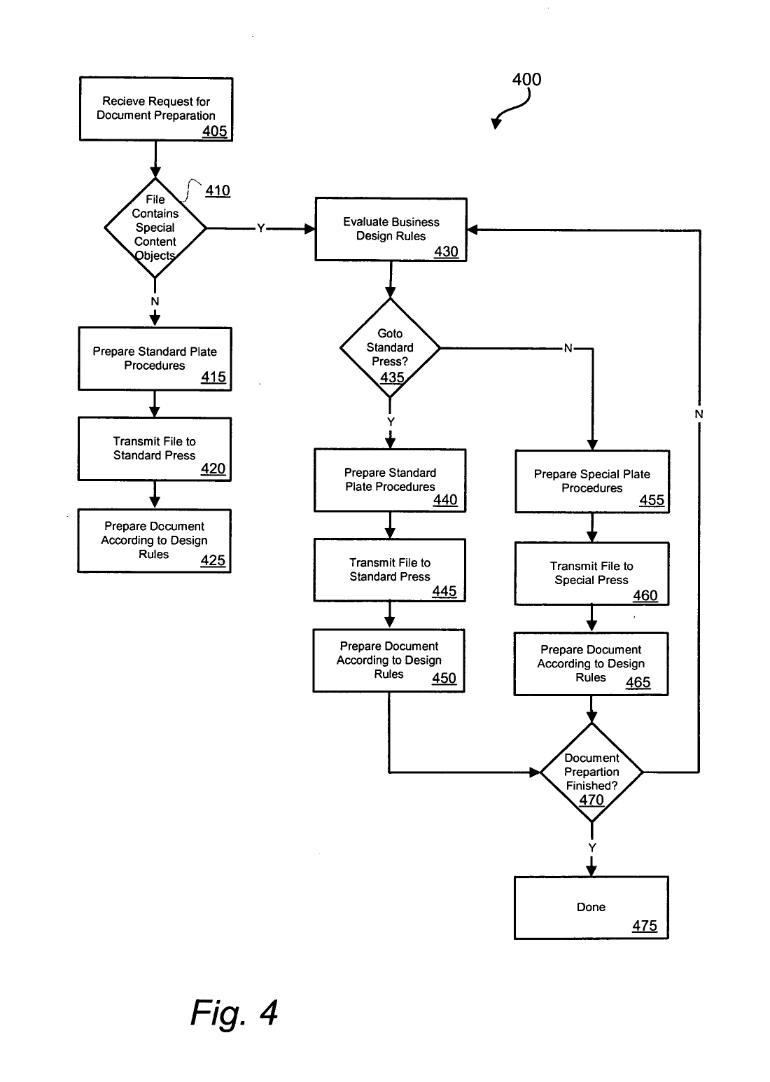

FIG. 4 is a flow diagram illustrating a document preparation process according to one embodiment of the invention. At block 405, a request for document preparation is received. The request may be received directly from the user interface or any other means known to those skilled in the art. A decision is made at decision block 410 as to whether the file contains special content objects. If the answer is no, then the standard plate procedures are prepared according to block 415. At block 420 the file is transmitted to the standard press and the document is prepared according to the design rules as indicated at block 425.

At block 410, if the determination is made that the file contains special content objects then the file is evaluated based on the business design rules as indicated by block 430. Block 435 is based on the business design rules of block 430. If the document preparation should go to the standard press, then the standard plate procedures are prepared as indicated by block 440. Block 445 transmits the file to the standard press and the document is prepared according to design rules at block 450. At block 470, if the determination is made that the document preparation is finished then nothing else happens as indicated by block 475. If, however, at block 470 the determination is made that the document preparation is not finished then a continued evaluation according to the business design rules at block 430 are made.

At block 435, if the determination is made not to go to a standard press, then the special plate procedures are prepared as indicated by block 455. Block 460 transmits the file to the standard press and the document is prepared according to design rules at block 465. At block 470, if the determination is made that the document preparation is finished then nothing else happens as indicated by block 475. If, however, at block 470 the determination is made that the document preparation is not finished then a continued evaluation according to the business design rules at block 430 are made.

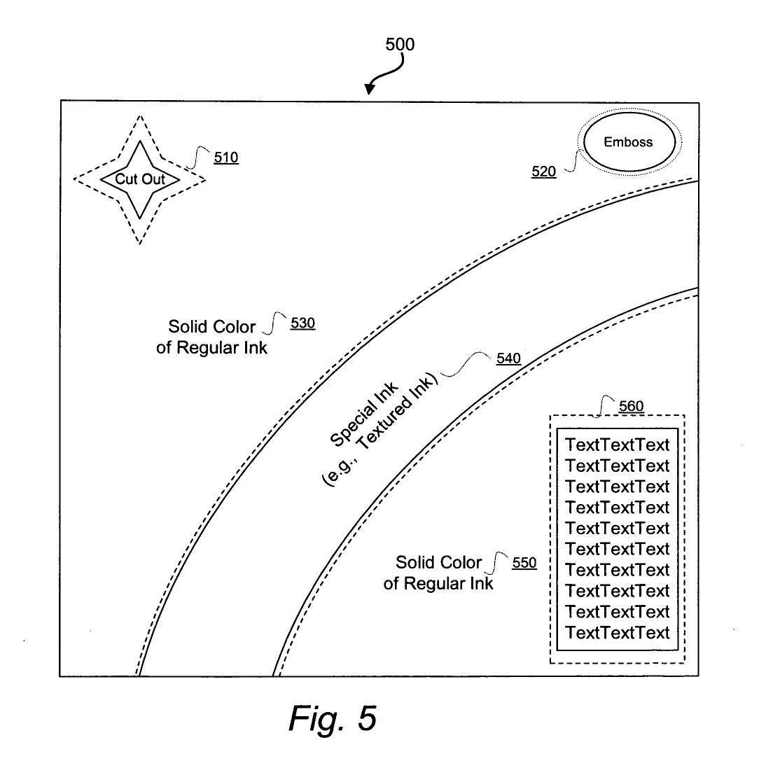

FIG. 5 illustrates how a media production might be represented by the UI in one embodiment of the present invention. In this exemplary media production, there are six different regions with different printing requirements. These regions include a cut out 510, an emboss 520, a solid color of regular ink 530, a special ink 540, another solid color of regular ink 550, and a text region 560. Encompassing each of these regions is a dotted line indicating the possible position of the region on the paper based upon the tolerances associated with the plate corresponding to the region. These dotted lines represent the trapping information for the plate that is being used. In some cases, this feature is helpful as it allows the user to place objects within the media production while knowing that when the document is printed the regions will not overlap in an undesired fashion.

The invention has now been described in detail for purposes of clarity and understanding. However, it will be appreciated that certain changes and modifications may be practiced within the scope of the appended claims. Thus, although the invention is described with reference to specific embodiments and figures thereof, the embodiments and figures are merely illustrative, and not limiting of the invention. Rather, the scope of the invention is to be determined solely by the appended claims.

What is claimed is:

1. A system for integrated extended process media productions, the system comprising:
a computer;
a computer readable medium accessible to the computer, wherein the computer readable medium includes instructions executable by the computer to:
receive a request for a special plate;
incorporate the special plate in a media production;
receive a request for a standard plate; and
incorporate the standard plate in the media production.

2. The system of claim 1, wherein the special plate is selected from a group consisting of: a varnish plate, a special effect ink, and a die.

3. The system of claim 2, wherein the special effect ink is selected from a group consisting of: a textured ink, a metallic ink, and a spot ink.

4. The system of claim 2, wherein the die is selected from a group consisting of: a foil stamp, an embossing, and a cutout.

5. The system of claim 1, wherein the special plate includes trapping information.

6. The system of claim 1, wherein the standard plate is selected from a group consisting of: a four color ink graphic and a four color ink text.

7. The system of claim 6, wherein the standard plate includes trapping information.

8. The system of claim 1, wherein the instructions executable by the computer are further executable to:
display the media production including both the special plate and the standard plate.

9. The system of claim 1, wherein the instructions executable by the computer are further executable to:
output the media production using an output model.

10. The system of claim 9, wherein the output model is a CMYK output model.

11. The system of claim 9, wherein the output model is a DeviceN output model.

12. The system of claim 9, wherein the output model is a host-based separation output model.

13. The system of claim 1, wherein the instructions executable by the computer are further executable to:
create the special plate; and
modify the special plate.

14. The system of claim 1, wherein the instructions executable by the computer are further executable to:
apply the special plate to a bezier line;
apply the special plate to a closed bezier path;
apply the special plate to a non-bezier line;
apply the special plate to a frame;
apply the special plate to a text character;
apply the special plate to a graphic;
apply the special plate to a clipping path in an imported graphic;
apply the special plate to a working path in an imported graphic; and
apply the special plate to spot inks in an imported graphic.

15. A method for developing media productions utilizing extended press functionality, the method comprising:
receiving a request for a special plate;
incorporating the special plate in a media production;
receiving a request for a standard plate; and
incorporating the standard plate in the media production.

16. The method of claim 15, wherein the special plate is selected from a group consisting of: a dull varnish plate, a glossy varnish plate, a ultra-violet coating varnish plate, a tint varnish plate, a spot ink special plate, a textured ink special plate, a metallic ink special plate, a foil stamp special plate, an embossing special plate, and a cutout special plate.

17. The method of claim 15, wherein the standard plate is selected from a group consisting of: a four color ink graphic and a four color ink text.

18. The method of claim 15, the method further comprising:
displaying the media production including both the special plate and the standard plate.

19. The method of claim 15, the method further comprising:
receiving a first press identification, wherein the first press identification indicates at least one capability of a first press;
receiving a first press selection, wherein the first press selection indicates the first press;
receiving a second press identification, wherein the second press identification indicates at least one capability of a second press; and
receiving a second press selection, wherein the second press selection indicates the second press.

20. The method of claim 19, the method further comprising:
identifying a main portion of the media production compatible with the first press;
identifying a remainder portion of the media production compatible with the second press; and
providing the main portion to the first press and the remainder portion to the second press.

21. A system for integrated extended process media productions, the system comprising:
a computer readable medium, wherein the computer readable medium is accessible by a computer, and wherein the computer readable medium includes instructions executable by the computer to:
receive a request for a special plate;
incorporate the special plate in a media production; and
display the media production with the special plate displayed in relation to other elements of the media production.

22. A method comprising:
a layout tool receiving an output request to output an integrated extended process media production created within the layout tool, the integrated extended process media production including at least one standard plate and at least one special plate; and
responsive to receiving the output request, based upon capabilities of a first printing press and a second printing press, the layout tool programmatically (i) identifying and associating with the first printing press a first portion of the integrated extended process media production that includes the at least one standard plate and is compatible with the capabilities of the first printing press, and (ii) identifying and associating with the second printing press a second portion of the integrated extended process media production that includes the at least one special plate and is compatible with the capabilities of the second printing press.

23. The method of claim 22, further comprising responsive to receiving the output request, the layout tool programmatically generating a first print job to be directed to the first printing press and a second print job to be directed to the second printing press.

24. The method of claim 22, wherein the at least one special plate is selected from a group consisting of: a dull varnish plate, a glossy varnish plate, a ultra-violet coating varnish plate, a tint varnish plate, a spot ink special plate, a textured ink special plate, a metallic ink special plate, a foil stamp special plate, an embossing special plate, and a cutout special plate.

25. The method of claim 22, wherein the at least one standard plate is selected from a group consisting of: a four color ink graphic and a four color ink text.

26. The method of claim 22, further comprising graphically depicting the integrated extended process media production including both the at least one special plate and the at least one standard plate.

27. The method of claim 22, further comprising:
receiving capability information associated with the first press; and
receiving capability information associated with the second press.
